(19) United States
(12) Patent Application Publication
(10) Pub. No.: US 2018/0002503 A1
(43) Pub. Date: Jan. 4, 2018

(54) METHOD FOR IMPREGNATING A FIBROUS SUBSTRATE WITH A (METH)ACRYLIC MIXTURE, COMPOSITION OF SAID (METH)ACRYLIC MIXTURE, AND COMPOSITE MATERIAL PRODUCED AFTER POLYMERISATION OF SAID (METH)ACRYLIC MIXTURE

(71) Applicant: Arkeme France, Colombes (FR)

(72) Inventors: Pierre Gerard, Denguin (FR); Gilles FRANCOIS, Porcelette (FR); Sébastien TAILLEMITE, Chaville (FR); Mélanie R. LAFARGE, Suresnes (FR)

(21) Appl. No.: 15/538,440

(22) PCT Filed: Dec. 22, 2015
(86) PCT No.: PCT/FR2015/053711

§ 371 Date: Jun. 21, 2017

(30) Foreign Application Priority Data
Dec. 22, 2014 (FR) 14 63058

(51) Int. Cl. C08J 5/24; C08J 5/04; B29K 105/00; B29K 33/00; B29C 70/48

(52) U.S. Cl. CPC C08J 5/24; C08J 5/043; B29C 70/48; B29K 2033/12; C08J 2333/12; B29K 2105/0005

(57) ABSTRACT

The present invention relates to a process for impregnating a fibrous substrate consisting of long fibers by a liquid (meth)acrylic mixture mainly containing methacrylic and/or acrylic components. The invention also relates to such a (meth)acrylic mixture and its composition, said (meth)acrylic mixture comprising a (meth)acrylic syrup and an aqueous dispersion of radical initiator. The invention also relates to a process for manufacturing mechanical parts or structured elements or articles made of composite material by impregnating the fibrous substrate with the (meth)acrylic mixture then polymerizing said (meth)acrylic mixture, and also such parts obtained according to said manufacturing process and used in varied fields such as the automotive industry, aeronautics, or else construction.

### FIELD OF THE INVENTION

The invention relates to a process for impregnating a fibrous substrate, a polymer-based liquid resin composition for carrying out said impregnation process, and the impregnated substrate obtained by carrying out said impregnation process.

More particularly, the invention relates to an industrial process for impregnating a fibrous substrate by a viscous liquid mixture based on methacrylic or acrylic components. Such a process makes it possible especially to obtain three-dimensional parts, for example mechanical parts or assemblies of mechanical parts, used in varied fields such as aeronautics, the automotive industry, or else rail transport or construction.

### PRIOR ART

Some parts, or some assemblies of parts, such as those mentioned above, are sometimes subject to high mechanical stresses or mechanical forces. Such parts are hence very widely manufactured from composite materials.

A composite material is an assembly of at least two immiscible components. A synergistic effect is obtained by such an assembly, such that the composite material obtained has especially mechanical and/or thermal properties that each of the initial components does not have, or does have but to a lesser extent than the composite material.

Moreover, a composite material consists of at least one reinforcing material, conferring good mechanical properties on said composite material, especially good resistance to the mechanical forces experienced by the composite material, and of a matrix material forming a continuous phase and ensuring the cohesion of said composite material. Among the different types of composites used in industry, composites containing organic matrices are the most represented. In the case of composites containing organic matrices, the matrix material is generally a polymer. This polymer may either be a thermosetting polymer or a thermoplastic polymer.

The composite material is prepared by mixing the matrix material and the reinforcing material, or by wetting or impregnating the reinforcing material with the matrix material, then by polymerizing the system obtained. In the case of the mixing of the matrix and the reinforcer, said reinforcer may consist of reinforcing fillers such as gravel, sand or glass beads. In the case of wetting or impregnating the reinforcer with the matrix, said reinforcer may consist of fibers of variable dimensions.

The polymer matrix generally comprises a polymerization initiator in order to polymerize the polymer matrix impregnating the reinforcing material. This polymerization initiator is often in solid form, and therefore has the drawback of forming a solid deposit in the polymer matrix by settling out. The matrix is thus highly heterogeneous and the subsequent polymerization, thus occurring in a heterogeneous medium, does not make it possible to obtain composite materials having good mechanical properties. Moreover, an initiator in solid form may cause obstruction of the feed lines of an injection machine used for synthesizing the composite material, thereby leading to the blockage thereof, or even the breakage thereof.

A first solution may consist in dissolving the initiator in a solvent such as acetone, ethanol or else a phthalate, but this gives rise to high costs and the presence of an organic solvent is not desirable in the processes for manufacturing such composite materials. Furthermore, the amount of solvent required to dissolve the initiator is generally too high and incompatible with the (meth)acrylic syrup/initiator system ratio of the machines. This is especially the case with benzoyl peroxide (BPO), for which the (meth)acrylic syrup/sum of (meth)acrylic syrup and initiator system ratio must be less than or equal to 5%.

An alternative solution is using a liquid initiator. However, the kinetics of the reactions used in the processes for manufacturing such composite materials are then markedly slower than in the case of using a solid initiator, despite the presence of a polymerization accelerator. Among liquid initiators, liquid peroxides are commonly used. Another drawback inherent to the use of liquid initiators, such as liquid peroxides, is the fact that they cannot be used in two-component systems, the first component being the (meth)acrylic syrup and the second component being the initiator system, because the accelerator is not stable in either of the two components.

Document U.S. Pat. No. 5,162,280 describes the production of an aqueous dispersion of aromatic diacyl peroxide, said aromatic diacyl peroxide being a polymerization initiator. This aqueous dispersion comprises, in addition to an aromatic diacyl peroxide, a diluent consisting of an alkylene glycol and two suspension agents respectively consisting of magnesium aluminum silicate and of a water-soluble cellulose ether. Thus, this document proposes a dispersion comprising an initiator of aromatic diacyl peroxide type in liquid form. However, this document does not describe the use of such a suspension for manufacturing polymer-based composite materials.

Document WO2010/112534 describes an aqueous dispersion comprising from 35% to 45% by weight of solid diacyl peroxide, the particles of which have a median diameter D50 of between 1 μm and 10 μm. The aqueous dispersion also comprises from 0.05% to 1% of dispersant, and also an amount of less than 1% of organic solvent.

Document WO2014/135816 describes a process for impregnating a fibrous substrate with a (meth)acrylic syrup comprising a (meth)acrylic polymer, a (meth)acrylic monomer, and fillers chosen from particles having a degree of swelling in the (meth)acrylic monomer of less than 200% and the mean diameter D50 of which is less than 50 μm. The syrup is polymerized by addition of an initiator, of which only benzoyl peroxide in a form of a slightly moist powder is described. This initiator is solid and is in the form of a BPO powder and not an aqueous dispersion of organic peroxide, in particular of BPO.

Document U.S. Pat. No. 5,300,600 describes the production of an aqueous dispersion of aromatic peroxide, which is usually solid at a temperature close to 20° C., said aromatic peroxide being a polymerization initiator. This aqueous dispersion also comprises, in addition to an aromatic peroxide, a dispersant consisting of a polyether alcohol and an oxidized phenolic resin. However, this document does not describe the use of such a suspension for manufacturing polymer-based composite materials. Furthermore, while the use of dispersant in the presence of the usually solid initiator in an aqueous dispersion makes it possible to obtain a liquid composition, the size of the initiator particles within the composition is generally such that these particles can still obstruct the feed lines of the injection machines which are often necessary for the manufacture of composite materials. Moreover, this type of liquid composition is not generally very stable, which may especially lead to a lack of reproducibility of the processes employing said liquid composition. Reference may also be made to document WO 2014013028, the impregnation process of which comprises similar drawbacks to those described above.

### Technical Problem

Thus, the aim of the invention is to overcome the drawbacks of the prior art by proposing a process for manufacturing parts or assemblies of parts based on polymeric composite material, which may be carried out on machines commonly used for the molding of said parts and/or of said assemblies of parts based on polymeric composite material, without causing any blockage or malfunctioning of such machines. Another aim of the invention is a process for impregnating a fibrous substrate with a (meth)acrylic mixture comprising a (meth)acrylic syrup and an aqueous dispersion of radical initiator consisting of an organic peroxide, said mixture being able to be employed on machines commonly used for the molding of said parts and/or of said assemblies of parts based on polymeric composite material, without causing any blockage or malfunctioning of such machines. Another aim of the invention is to propose parts obtained by the process, also having good mechanical properties.

### BRIEF DESCRIPTION OF THE INVENTION

To this end, one subject of the invention is a process for impregnating a fibrous substrate preferentially consisting of long fibers, said process being mainly characterized in that it comprises a step of impregnating said fibrous substrate with a liquid (meth)acrylic mixture comprising:
a (meth)acrylic syrup comprising at least one (meth)acrylic polymer and at least one (meth)acrylic monomer,
an aqueous dispersion comprising at least one radical initiator consisting of an organic peroxide, for initiating the polymerization of the (meth)acrylic monomer, said at least one radical initiator having a particle size such that the median diameter of the particles by volume (D50) is between 1 μm and 30 μm, preferably between 2 μm and 25 μm, even more preferably between 3.5 μm and 20 μm, advantageously between 3.5 μm and 15 μm, more advantageously between 3.5 μm and 13 μm and even more advantageously between 3.5 μm and 12 μm.

According to other optional characteristics of the impregnation process:
The step of impregnating the fibrous substrate is carried out in a closed mold,
The radical initiator is chosen from diacyl peroxides, peroxy esters, dialkyl peroxides, peroxyacetals and azo compounds,
The radical initiator consists of benzoyl peroxide (BPO),
The content of radical initiator relative to the (meth)acrylic monomer or to the mixture of (meth)acrylic monomers is between 100 and 50 000 ppm by weight, preferably between 200 and 40 000 ppm by weight and advantageously between 300 and 30 000 ppm by weight,
The percentage by weight of radical initiator in the aqueous dispersion is between 30% and 80%, preferably between 35% and 70%, and even more preferably is between 35% and 60%,
The percentage by weight of radical initiator in the (meth)acrylic mixture is less than 5%, preferably less than 3%, and even more preferably less than 2.5%,
The percentage by weight of radical initiator in the (meth)acrylic mixture is greater than 0.2%, preferably greater than 0.4%, and even more preferably greater than 0.5%,
The aqueous dispersion of radical initiator has a viscosity at 20° C. of between 50 mPa*s and 1000 mPa*s, preferably between 100 mPa*s and 750 mPa*s, and even more preferably between 200 mPa*s and 500 mPa*s,
The radical initiator has a particle size such that the diameter D10 of the particles by volume is less than 20 μm, preferably less than 15 μm and even more preferably less than 10 μm,
The aqueous dispersion of radical initiator preferably comprises an emulsifier,
The aqueous dispersion of radical initiator preferably comprises a stabilizer,
The liquid (meth)acrylic syrup has a dynamic viscosity of between 10 mPa's and 10 000 mPa's, preferably between 50 mPa's and 5000 mPa's and advantageously between 100 mPa's and 1000 mPa's, the dynamic viscosity being measured at 25° C.,
The (meth)acrylic polymer is a homopolymer of methyl methacrylate (MMA) or a copolymer of methyl methacrylate (MMA) or one of the mixtures thereof,
The copolymer of methyl methacrylate (MMA) comprises at least 70%, preferably at least 80%, advantageously at least 90% and more advantageously at least 95% by weight of methyl methacrylate (MMA),
The copolymer of methyl methacrylate (MMA) comprises from 80% to 99.7%, advantageously from 90% to 99.7% and more advantageously from 90% to 99.5% by weight of methyl methacrylate and from 0.3% to 20%, advantageously from 0.3% to 10% and more advantageously from 0.5% to 10% by weight of at least one monomer containing at least one ethylenic unsaturation that can copolymerize with methyl methacrylate,
The (meth)acrylic polymer in the liquid (meth)acrylic mixture is present at an amount of at least 10% by weight, preferably at least 15%, advantageously at least 18% and more advantageously at least 20% by weight of the total liquid (meth)acrylic mixture,
The (meth)acrylic polymer in the liquid (meth)acrylic mixture is present at an amount of at most 60% by weight, preferably at most 50%, advantageously at most 40% and more advantageously at most 35% by weight of the total liquid (meth)acrylic mixture,
The (meth)acrylic monomer is chosen from acrylic acid, methacrylic acid, alkyl acrylic monomers, alkyl methacrylic monomers and mixtures thereof, the alkyl group possibly being linear, branched or cyclic and containing from 1 to 22 carbon atoms, preferably from 1 to 12 carbon atoms,
The (meth)acrylic monomer is chosen from methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate and isobornyl methacrylate, and mixtures thereof,
The (meth)acrylic monomer is chosen from methyl methacrylate, isobornyl acrylate and acrylic acid, and mixtures thereof,
50% by weight of the (meth)acrylic monomer or the (meth)acrylic monomers is methyl methacrylate,
The (meth)acrylic syrup also comprises at least one filler and/or at least one additive, such as impact strength modifiers or block copolymers, thermal stabilizers, UV stabilizers, flame retardants, lubricants, mold release agents, dyes, or mixtures thereof,
The additives are chosen from impact strength modifiers or block copolymers, thermal stabilizers, UV stabilizers, flame retardants, lubricants, mold release agents, dyes, or mixtures thereof, and are present in the liquid (meth)acrylic mixture at a content of between 0.01% by weight and 50% by weight, such that the dynamic viscosity of the (meth)acrylic syrup is between 10 mPa*s and 1000 mPa*s,
The fillers are chosen from calcium carbonate (CaCO₃), titanium dioxide (TiO₂), and silica (SiO₂), and are present in the aqueous dispersion at a content of between 0.01% by weight and 40% by weight, such that the dynamic viscosity of the liquid (meth)acrylic syrup is between 10 mPa*s and 1000 mPa*s,
The (meth)acrylic mixture also comprises an activator in the (meth)acrylic syrup,
The activator is chosen from tertiary amines such as N,N-dimethyl-p-toluidine (DMPT), N,N-dihydroxyethyl-p-toluidine (DHEPT), transition metal catalysts which are soluble in organic compounds, or mixtures thereof,
The content of the activator relative to the (meth)acrylic monomer of the liquid (meth)acrylic syrup is from 100 ppm to 10 000 ppm by weight, preferably from 200 ppm to 7000 ppm by weight and advantageously from 300 ppm to 4000 ppm by weight,
The (meth)acrylic mixture comprises between 95% and 99% by weight, preferably between 96% and 98.5% by weight, and even more preferably between 97% and 98% by weight of (meth)acrylic syrup, and between 1% and 5% by weight, preferably between 1.5% and 4% by weight, and even more preferably between 2% and 3% by weight of aqueous dispersion.

The invention also relates to a liquid (meth)acrylic mixture for carrying out the process for impregnating a fibrous substrate, said mixture being characterized in that it comprises:
a (meth)acrylic syrup comprising at least one (meth)acrylic polymer and at least one (meth)acrylic monomer,
an aqueous dispersion comprising at least one radical initiator consisting of an organic peroxide, for initiating the polymerization of the (meth)acrylic monomer, said at least one radical initiator having a particle size such that the median diameter of the particles by volume (D50) is between 1 μm and 30 μm, preferably between 2 μm and 25 μm, and even more preferably between 3.5 μm and 20 μm and advantageously between 3.5 μm and 15 μm.

The invention also relates to a process for manufacturing mechanical parts or structured elements or articles, said process being mainly characterized in that it comprises the following steps:
a) impregnating a fibrous substrate with a liquid (meth)acrylic mixture
b) polymerizing the liquid (meth)acrylic mixture impregnating said fibrous substrate.

According to other optional characteristics of the manufacturing process:
The process also comprises, prior to step a), a step of preparing the liquid (meth)acrylic mixture by mixing a (meth)acrylic syrup comprising at least one (meth)acrylic polymer and at least one (meth)acrylic monomer with an aqueous dispersion comprising at least one radical initiator consisting of an organic peroxide for initiating the polymerization of the (meth)acrylic monomer, said at least one radical initiator having a particle size such that the median diameter of the particles by volume (D50) is between 1 μm and 30 μm, preferably between 2 μm and 25 μm and even more preferably between 3.5 μm and 20 μm and advantageously between 3.5 μm and 15 μm, more advantageously between 3.5 μm and 13 μm and even more advantageously between 3.5 μm and 12 μm,
The impregnation of the fibrous substrate in step a) is performed in a closed mold,
Step a) and step b) are performed in the same closed mold,
The process is chosen from resin transfer molding and infusion.

The invention also relates to a mechanical or structural part made of composite material obtained via the manufacturing process. Said part may especially be a motor vehicle part, boat part, train part, sport article, plane or helicopter part, spaceship or rocket part, photovoltaic module part, wind turbine part, furniture part, construction or building part, telephone or cellphone part, computer or television part, printer or photocopier part.

### DETAILED DESCRIPTION OF THE INVENTION

### The Process for Impregnating a Fibrous Substrate

The process for impregnating a fibrous substrate comprises a step of impregnating said fibrous substrate with a (meth)acrylic mixture, in which the mixture comprises:
a liquid (meth)acrylic syrup comprising at least one (meth)acrylic polymer and at least one (meth)acrylic monomer,
an aqueous dispersion comprising at least one radical initiator. Advantageously, the radical initiator consists of an organic peroxide, the particle size of which is such that the median diameter of the particles by volume (D50) is between 1 μm and 30 μm, preferably between 2 μm and 25 μm, and even more preferably between 3.5 μm and 20 μm and advantageously between 3.5 μm and 15 μm, more advantageously between 3.5 μm and 13 μm and even more advantageously between 3.5 μm and 12 μm.

The term “(meth)acrylic mixture” corresponds to the polymer matrix as described above. The “(meth)acrylic syrup” that this mixture comprises is referred to in this way due to the liquid and viscous appearance thereof, and may also be termed a prepolymer due to the fact that it comprises at least one (meth)acrylic monomer able to undergo a polymerization in order to form a (meth)acrylic polymer.

The term “fibrous substrate” as used refers to fabrics, felts or nonwovens that may be in the form of strips, laps, braids, locks or pieces.

The term “(meth)acrylic” as used refers to any type of acrylic and methacrylic monomers.

The term “monomer” as used relates to a molecule which can undergo a polymerization.

The term “polymerization” as used relates to the process for conversion of a monomer or of a mixture of monomers into a polymer.

The term “composite material” as used refers to a multicomponent material comprising several different phase domains, among which at least one type of phase domain is a continuous phase and in which at least one component is a polymer.

The term “initiator” as used refers to a chemical species that reacts with a monomer to form an intermediate compound capable of bonding successfully with a large number of other monomers in order to form a polymer compound.

“D50” or “median diameter” is intended to mean the particle diameter which divides the distribution of the particles of a substance into two parts with equal areas. In the case of the median diameter D50 by volume, 50% of the total volume of the particles corresponds to the volume of particles with a diameter less than D50, and 50% of the total volume of the particles corresponds to the volume of particles with a diameter greater than D50.

“D10” is intended to mean the particle diameter which divides the distribution of the particles of a substance into two parts with areas in a ratio of 10%/90%. In the case of D10 by volume, 10% of the total volume of the particles corresponds to the volume of particles with a diameter less than D10, and 90% of the total volume of the particles corresponds to the volume of particles with a diameter greater than D10.

### The (Meth)Acrylic Polymer

The (meth)acrylic polymer may be chosen from polyalkyl methacrylates or polyalkyl acrylates. According to a preferred embodiment, the (meth)acrylic polymer is polymethyl methacrylate (PMMA). It should consequently be understood that polymethyl methacrylate (PMMA) may denote a homopolymer of methyl methacrylate (MMA) or a copolymer of MMA or mixtures thereof.

In particular, it may be a mixture of at least two homopolymers of MMA having a different molecular weight, or a mixture of at least two copolymers of MMA having an identical monomer composition and a different molecular weight, or a mixture of at least two copolymers of MMA having a different monomer composition. It may also be a mixture of at least one homopolymer of MMA and of at least one copolymer of MMA.

According to one embodiment, the copolymer of MMA comprises at least 70%, preferably at least 80%, advantageously at least 90% and more advantageously at least 95% by weight of methyl methacrylate. The copolymer of MMA may also comprise from 0.3% to 30% by weight of at least one monomer, containing at least one ethylenic unsaturation, that can copolymerize with the methyl methacrylate. Among these monomers, mention may be made especially of: acrylic and methacrylic acids and alkyl (meth)acrylates in which the alkyl group contains from 1 to 12 carbon atoms. As examples, mention may be made of methyl acrylate and ethyl, butyl or 2-ethylhexyl (meth)acrylate. Preferably, the comonomer is an alkyl acrylate in which the alkyl group contains from 1 to 4 carbon atoms.

According to a preferred embodiment, the copolymer of methyl methacrylate (MMA) comprises from 80% to 99.7%, advantageously from 90% to 99.7% and more advantageously from 90% to 99.5% by weight of methyl methacrylate and from 0.3% to 20%, advantageously from 0.3% to 10% and more advantageously from 0.5% to 10% by weight of at least one monomer, containing at least one ethylenic unsaturation, that can copolymerize with methyl the methacrylate. Preferably, the comonomer is chosen from methyl acrylate or ethyl acrylate or mixtures thereof.

The (meth)acrylic polymer(s) in the liquid (meth)acrylic syrup are present at an amount of at least 10% by weight, preferably at least 15%, advantageously at least 18% and more advantageously at least 20% by weight of the total liquid (meth)acrylic syrup.

The (meth)acrylic polymer(s) in the liquid (meth)acrylic syrup are present at an amount of at most 60% by weight, preferably at most 50%, advantageously at most 40% and more advantageously at most 35% by weight of the total liquid (meth)acrylic syrup.

The weight-average molecular weight of the (meth)acrylic polymer is generally high, and may consequently be greater than 50 000 g/mol, preferably greater than 100 000 g/mol. The weight-average molecular weight may be measured by size exclusion chromatography (SEC).

### The (Meth)Acrylic Monomer

The (meth)acrylic monomer(s) contained in the (meth)acrylic syrup in addition to the (meth)acrylic polymer may be chosen from acrylic acid, methacrylic acid, alkyl acrylic monomers, alkyl methacrylic monomers and mixtures thereof.

The (meth)acrylic monomer is preferably chosen from acrylic acid, methacrylic acid, alkyl acrylic monomers, alkyl methacrylic monomers and mixtures thereof, the alkyl group possibly being linear, branched or cyclic and containing from 1 to 22 carbon atoms, preferably from 1 to 12 carbon atoms.

Advantageously, the (meth)acrylic monomer is chosen from methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate and isobornyl methacrylate, and mixtures thereof.

More advantageously, the (meth)acrylic monomer is chosen from methyl methacrylate, isobornyl acrylate and acrylic acid, and mixtures thereof.

According to a preferred embodiment, at least 50% by weight, preferably at least 60% by weight, of the (meth)acrylic monomer or (meth)acrylic monomers is methyl methacrylate.

According to a more preferred embodiment, at least 50% by weight, preferably at least 60% by weight, more preferably at least 70% by weight, advantageously at least 80% by weight and even more advantageously 90% by weight of the (meth)acrylic monomer is a mixture of methyl methacrylate with isobornyl acrylate and/or acrylic acid.

The (meth)acrylic monomer or the (meth)acrylic monomers in the liquid (meth)acrylic syrup are present at an amount of at least 40% by weight, preferably 50% by weight, advantageously 60% by weight and more advantageously 65% by weight of the total liquid (meth)acrylic syrup.

### The Fibrous Substrate

As regards the fibrous substrate, mention may be made of fabrics, felts or nonwovens that may be in the form of strips, laps, braids, locks or pieces. The fibrous material may have various forms and dimensions, either one-dimensional, two-dimensional or three-dimensional. A fibrous substrate comprises an assembly of one or more fibers. When the fibers are continuous, their assembly forms fabrics.

The one-dimensional form corresponds to linear fibers. The fibers may be discontinuous or continuous. The fibers may be arranged randomly or in the form of a continuous filament parallel to each other. A fiber is defined by its aspect ratio, which is the ratio between the length and the diameter of the fiber. The fibers used in the present invention are long fibers or continuous fibers. The fibers have an aspect ratio of at least 1000, preferably at least 1500, more preferably at least 2000, advantageously at least 3000 and most advantageously at least 5000.

The two-dimensional form corresponds to nonwoven reinforcements or fibrous mats or woven rovings or bundles of fibers, which may also be braided.

The three-dimensional form corresponds, for example, to nonwoven reinforcements or fibrous mats or stacked or folded bundles of fibers or mixtures thereof, an assembly of the two-dimensional form in the third dimension.

The origins of the fibrous material may be natural or synthetic. Natural materials that may be mentioned include plant fibers, wood fibers, animal fibers or mineral fibers.

Natural fibers are for example sisal, jute, hemp, flax, cotton, coconut fibers, and banana fibers. Animal fibers are, for example, wool or hair.

Synthetic materials that may be mentioned include polymeric fibers chosen from fibers of thermosetting polymers, of thermoplastic polymers or mixtures thereof.

The polymeric fibers may consist of polyamide (aliphatic or aromatic), polyester, polyvinyl alcohol, polyolefins, polyurethanes, polyvinyl chloride, polyethylene, unsaturated polyesters, epoxy resins and vinyl esters.

The mineral fibers may also be chosen from glass fibers especially of type E, R or S2, carbon fibers, boron fibers or silica fibers.

The fibrous substrate of the present invention is chosen from plant fibers, wood fibers, animal fibers, mineral fibers, synthetic polymeric fibers, glass fibers and carbon fibers, and mixtures thereof. Preferably, the fibrous substrate is chosen from mineral fibers.

### The Aqueous Dispersion

The (meth)acrylic mixture comprises an aqueous dispersion comprising at least one initiator for initiating the polymerization of the (meth)acrylic monomer(s) contained in the (meth)acrylic syrup in addition to the (meth)acrylic polymer(s).

The aqueous dispersion comprising at least one initiator for initiating the polymerization is not a filler, since the initiator reacts to initiate the polymerization.

Mention may be made, for example, of heat-activated initiators or initiating systems. The heat-activated initiator is preferably a radical initiator. Said radical initiator may be chosen from diacyl peroxides, peroxy esters, dialkyl peroxides, peroxyacetals and azo compounds,

The initiator is preferably chosen from isopropyl carbonate, benzoyl peroxide, lauroyl peroxide, caproyl peroxide, dicumyl peroxide, tert-butyl perbenzoate, tert-butyl per (2-ethylhexanoate), cumyl hydroperoxide, 1,1-di(tert-butylperoxy)-3,3,5-trimethylcyclohexane, tert-butyl peroxyisobutyrate, tert-butyl peracetate, tert-butyl perpivalate, amyl perpivalate, tert-butyl peroctoate, azobisisobutyronitrile (AIBN), azobisisobutyramide, 2,2′-azobis(2,4-dimethylvaleronitrile) and 4,4′-azobis(4-cyanopentanoic) acid. It would not be a departure from the scope of the invention to use a mixture of radical initiators chosen from the above list.

The initiator is preferably chosen from peroxides containing 2 to 20 carbon atoms. More preferably, the initiator is benzoyl peroxide (BPO).

The content of radical initiator relative to the (meth)acrylic monomer or to the mixture of (meth)acrylic monomers of the liquid (meth)acrylic syrup is between 100 and 50 000 ppm by weight (50 000 ppm=5% by weight), preferably between 200 and 40 000 ppm by weight and advantageously between 300 and 30 000 ppm by weight.

The aqueous dispersion advantageously comprises between 30% and 80%, preferably between 35% and 70%, and even more preferably between 35% and 60% of radical initiator. Such an aqueous dispersion comprising a high content of organic peroxide contributes to enabling optimal and full polymerization of the (meth)acrylic mixture.

The aqueous dispersion advantageously comprises between 0.01% and 10%, preferably between 0.05% and 7%, and even more preferably between 0.1% and 5% of a surfactant.

The aqueous dispersion advantageously comprises between 0.01% and 10%, preferably between 0.05% and 7%, and even more preferably between 0.1% and 5% of a stabilizer.

According to one embodiment of the invention, the percentage by weight of the radical initiator in the (meth)acrylic mixture comprising the (meth)acrylic syrup and the dispersion of radical initiator is less than 5%, preferably less than 3%, and even more preferably less than 2.5%.

The viscosity of the aqueous dispersion of radical initiator is between 50 mPa*s and 1000 mPa*s, preferably between 100 mPa*s and 750 mPa*s, and even more preferably between 200 mPa*s and 500 mPa*s, said viscosity being measured at 20° C. and 50 rpm. The viscosity may be measured with a rheometer or a viscometer, for example a Brookfield-type viscometer such as the Brookfield DVII.

Moreover, the particle size of the initiator of the aqueous dispersion is such that the median diameter of the particles by volume (D50) is between 1 μm and 30 μm, preferably between 2 μm and 25 μm, and even more preferably between 3.5 μm and 20 μm and advantageously between 3.5 μm and 15 μm, more advantageously between 3.5 μm and 13 μm and even more advantageously between 3.5 μm and 12 μm.

Such a particle size makes it possible to obtain a homogeneous dispersion of the initiator in the water, thereby promoting the impregnation of the fibrous substrate by the mixture comprising said aqueous dispersion and the (meth)acrylic syrup. The homogeneity of the dispersion also enables optimal and full polymerization of the (meth)acrylic syrup subsequent to the impregnation of the fibrous substrate by said (meth)acrylic syrup.

Such a polymerization according to the invention leads to high molecular weights, generally greater than 100 000 g/mol, preferentially greater than 500 000 g/mol, and even more preferably greater than 1 000 000 g/mol. Such molecular weight values make it possible to obtain a composite material having very good mechanical properties.

Such a particle size also makes it possible to obtain a stable aqueous dispersion of radical initiator, such that the initiator is entirely soluble in said aqueous dispersion and in the (meth)acrylic mixture obtained after mixing of the (meth)acrylic syrup and said aqueous dispersion.

The aqueous dispersion according to the invention, before being mixed with the (meth)acrylic syrup to form the (meth)acrylic mixture, does not obstruct the feed lines of the injection machine used to carry out the process for impregnating the fibrous substrate and/or the process for manufacturing mechanical parts or structured elements or articles made of composite material according to the invention, and is also not able to obstruct said feed lines of the injection machine.

Moreover, after mixing the aqueous dispersion according to the invention with the (meth)acrylic syrup to form the (meth)acrylic mixture, said (meth)acrylic mixture does not obstruct the injection lines of the injection machine used to carry out the process for impregnating the fibrous substrate and/or the process for manufacturing mechanical parts or structured elements or articles made of composite material according to the invention, and is also not able to obstruct said injection lines of the injection machine.

One advantage of such an aqueous dispersion of radical initiator according to the invention is its good dissolution in the (meth)acrylic syrup, so as to form a homogeneous (meth)acrylic mixture. It is thus possible to use a static mixer to mix the aqueous dispersion of radical initiator with the (meth)acrylic syrup. Of course, it is still possible to use other types of mixers suited to the production of such a mixture, such as a mechanical mixer or a rotating vessel mixer.

Another advantage of such an aqueous dispersion of radical initiator according to the invention is to enable homogeneous polymerization of the (meth)acrylic mixture. In particular, polymerization is homogeneous throughout the volume of the mold used for the process for impregnating the fibrous substrate and/or for the process for manufacturing parts made of composite material, thus leading to the formation of regular parts which have a reduced number of imperfections compared to the parts made of composite material obtained according to a different manufacturing process than that described in the present document.

The (meth)acrylic monomer or the mixture of (meth)acrylic monomers as defined above may optionally be accompanied by a suitable inhibitor in order to prevent said (meth)acrylic monomer from spontaneously polymerizing. Such an inhibitor may be incorporated into the (meth)acrylic syrup. Among suitable inhibitors, mention may especially be made of hydroquinone (HQ), methylhydroquinone (MEHQ), 2,6-di-tert-butyl-4-methoxyphenol (Topanol O) and 2,4-dimethyl-6-tert-butylphenol (Topanol A).

The (meth)acrylic mixture may also contain an activator for the polymerization, said activator possibly being incorporated into the (meth)acrylic syrup.

The polymerization activator or accelerator is chosen from tertiary amines such as N,N-dimethyl-p-toluidine (DMPT), N,N-dihydroxyethyl-p-toluidine (DHEPT), transition metal catalysts which are soluble in organic compounds, or mixtures thereof.

Advantageously, the liquid (meth)acrylic syrup does not contain any metal-based catalysts.

The content of the activator relative to the (meth)acrylic monomer of the liquid (meth)acrylic syrup is from 100 ppm to 10 000 ppm by weight, preferably from 200 ppm to 7000 ppm and advantageously from 300 ppm to 4000 ppm by weight.

The presence of activators or accelerators depends upon the final application. When cold-cure polymerization is necessary or desired, an accelerator is generally necessary. Cold-cure polymerization means that the polymerization takes place at room temperature, or generally at a temperature of less than 40° C. Nonetheless, for industrial applications, it is possible to carry out hot polymerization, hence at a temperature of greater than 40° C.

The (meth)acrylic mixture may also comprise a chain limiter in order to regulate the molecular weight of the polymer(s) formed. This may be, for example, γ-terpinene or terpinolene. The content of the limiting agent is generally between 0 and 500 ppm and preferably between 0 and 100 ppm relative to the (meth)acrylic monomer or to the mixture of (meth)acrylic monomers of the (meth)acrylic syrup.

The (meth)acrylic mixture may also comprise other additives and fillers. A filler is not considered to be an additive in the context of the present invention. Such fillers and additives may be incorporated into the (meth)acrylic syrup. Moreover, the additives and/or the fillers may be added to the (meth)acrylic mixture before the impregnation.

As additives, mention may be made of organic additives such as impact strength modifiers or block copolymers, thermal stabilizers, UV stabilizers, lubricants and mixtures thereof.

The impact strength modifier is in the form of fine particles comprising an elastomeric core and at least one thermoplastic shell, the size of the particles being in general less than 1 μm and advantageously between 50 and 300 m. The impact strength modifier is prepared by emulsion polymerization. The impact strength modifier content in the liquid (meth)acrylic syrup is from 0 to 50% by weight, preferably from 0 to 25% by weight and advantageously from 0 to 20% by weight.

The additives are preferably chosen from impact strength modifiers or block copolymers, thermal stabilizers, UV stabilizers, flame retardants, lubricants, mold release agents, dyes, or mixtures thereof.

The additives are present in the (meth)acrylic mixture at a content of between 0.01% by weight and 50% by weight, such that the dynamic viscosity of the (meth)acrylic syrup is between 10 mPa*s and 1000 mPa*s at 20° C.

As fillers, mention may be made of carbon nanotubes or mineral fillers including mineral nanofillers (TiO₂, silica).

The fillers are preferably chosen from calcium carbonate (CaCO₃), titanium dioxide (TiO₂), and silica (SiO₂).

The fillers are present in the aqueous dispersion at a content of between 0.01% by weight and 40% by weight, such that the dynamic viscosity of the liquid (meth)acrylic mixture is between 10 mPa*s and 1000 mPa*s at 20° C.

Moreover, advantageously, the (meth)acrylic mixture comprises between 95% and 99% by weight, preferably between 96% and 98.5% by weight, and even more preferably between 97% and 98% by weight of (meth)acrylic syrup, and between 1% and 5% by weight, preferably between 1.5% and 4% by weight, and even more preferably between 2% and 3% by weight of aqueous dispersion.

The process for manufacturing mechanical parts or structured elements or articles

The process comprises the following steps:
a) impregnating a fibrous substrate with a liquid (meth)acrylic mixture,
b) polymerizing the liquid (meth)acrylic mixture impregnating said fibrous substrate.

The impregnation of the fibrous substrate in step a) is preferably performed in a closed mold. Advantageously, step a) and step b) are performed in the same closed mold.

The mechanical parts or the structured elements or the articles based on composite material may be obtained according to different processes. Mention may be made of infusion, vacuum bag molding, pressure bag molding, autoclave molding, resin transfer molding (RTM), reaction injection molding (RIM), reinforced reaction injection molding (R-RIM) and variants thereof, press molding or compression molding.

The preferred manufacturing processes for manufacturing mechanical parts or structured elements or articles based on composite material are processes according to which the liquid (meth)acrylic mixture is transferred to the fibrous substrate by impregnation of said fibrous substrate in a mold, more preferably in a closed mold.

Advantageously, the manufacturing process is chosen from resin transfer molding and infusion.

All the processes comprise the step of impregnating the fibrous substrate with the liquid (meth)acrylic mixture before the step of polymerization in a mold. The step of polymerization of the liquid (meth)acrylic mixture impregnating said fibrous substrate takes place after the step of impregnation in the same mold.

Resin transfer molding is a process using a two-sided mold set which forms the two surfaces of a composite material. The lower side is a rigid mold. The upper side may be a rigid or flexible mold. Flexible molds can be made from composite materials, silicone or extruded polymer films such as nylon. The two sides fit together to form a mold cavity. The distinguishing feature of resin transfer molding is that the fibrous substrate is placed into this cavity and the mold set is closed prior to the introduction of the liquid (meth)acrylic syrup. Resin transfer molding comprises numerous variations which differ in the mechanics of introduction of the liquid (meth)acrylic syrup into the fibrous substrate in the mold cavity. These variations range from vacuum infusion to vacuum assisted resin transfer molding (VARTM). This process may be performed at room temperature or elevated temperature.

With the infusion process, the liquid (meth)acrylic syrup must have the appropriate viscosity for this process for preparing the polymeric composite material. The liquid (meth)acrylic syrup is sucked into the fibrous substrate, which is in a special mold, by applying a gentle vacuum. The fibrous substrate is infused and completely impregnated by the liquid (meth)acrylic syrup.

One advantage of this process is the large amount of fibrous material in the composite.

In order to carry out the process for impregnating the fibrous substrate and/or the process for manufacturing parts made of composite material, it is possible to use an injection machine, a first inlet of which is supplied with the (meth)acrylic syrup, and a second inlet of which is supplied with the dispersion of radical initiator. The syrup and the dispersion are then conveyed to a mixer, where they are mixed so as to obtain a substantially homogeneous (meth)acrylic mixture, then injected into a mold in which a fibrous substrate has been previously deposited. Said fibrous substrate is impregnated with the (meth)acrylic mixture, then polymerization of the system obtained makes it possible to form a part made of composite material.

The outlet flow rate, that is to say the flow rate of injection of the (meth)acrylic mixture into the mold, is preferably less than 4 kg/minute, preferably less than 3.4 kg/minute.

As regards the use of the mechanical parts or structured elements or articles manufactured, mention may be made of automotive applications, nautical applications, railroad applications, sport, aeronautics and aerospace applications, photovoltaic applications, computer-related applications, telecommunication applications and wind energy applications.

The mechanical parts are especially motor vehicle parts, boat parts, train parts, sport articles, plane or helicopter parts, spaceship or rocket parts, photovoltaic module parts, wind turbine parts, furniture parts, construction or building parts, telephone or cellphone parts, computer or television parts, printer and photocopier parts.

### EXAMPLES

A (meth)acrylic syrup is prepared by dissolving 25 parts by weight of a copolymer (PMMA—polyethyl acrylate) of BS520 type in 75 parts by weight of methyl methacrylate stabilized with HQME (hydroquinone monomethyl ether) and 0.5 part by weight of N,N-ihydroxyethyl-p-toluidine (DHEPT). The (meth)acrylic syrup obtained in this way is referred to as component A.

Three different formulations of benzoyl peroxide (BPO) are prepared, the BPO being referred to as component B. The different formulations, denoted by BPO 1, BPO 2 and BPO 3, are indicated in table I below. The viscosity of these formulations is measured by means of a Brookfield-type viscometer at 50 rpm and 20° C. The particle size and the diameter D50 of the dispersions or suspensions of BPO are measured by laser diffraction using a HELOS SUCELL apparatus from Sympatec GmbH. The different formulations of BPO are sold under the trade names Luperox® ANS50G, Luperox® A40FP-EZ9, and Perkadox® L-40RPS, by Arkema.

TABLE 1
formulations of BPO

| | | | | Viscosity |
|---|---|---|---|---|
| Component | | | D50 | at 50 rpm |
| B | | | [μm] | [mPas*s] |
| BPO 1 | Luperox ® | Aqueous dispersion | 43 | 44*10³ |
| | ANS50G | of BPO at 50% by | | |
| | | weight with | | |
| | | dibutylmaleate | | |
| BPO 2 | Luperox ® | Aqueous dispersion | 10 | 386 |
| | A40FP-EZ9 | of BPO at 38-42% | | |
| | | by weight | | |
| BPO 3 | Perkadox ® | Suspension of BPO | 15 | 568 |
| | L-40RPS | | | |

The methacrylic syrup (component A) and the different formulations of BPO (component B) indicated above may be used for molding by the RTM process, using the Patriot™ Pro Thermoplastic Resin Injection System injection machine, manufactured by Magnum Venus Products, Kent (WA). This is a pneumatic machine which operates with a maximum compressed air pressure of 7 bar, with recirculation loops and cleaning systems for each of the components. The outlet flow rate may extend up to 3.4 kg per minute, the content by volume of component B relative to component A is between 1.0% and 4.5%.

The liquid (meth)acrylic mixture comprising the (meth)acrylic syrup and one of the above formulations is injected into a closed mold comprising a glass fabric as fibrous substrate and polymerized at 25° C. for 40 to 50 minutes.
With the formulation BPO 1, only two parts could be produced. The machine subsequently became jammed. The main filter and the injection lines were blocked.
With the formulation BPO 2, a range of 30 parts was produced over several days, requiring no intervention on the machine.
With the formulation BPO 3, the machine's filter became blocked after a few minutes of operation, requiring stoppage and full cleaning of the machine before starting up again.

1. A process for impregnating a fibrous substrate, wherein said process comprises a step of impregnating said fibrous substrate with a liquid (meth)acrylic mixture comprising:
a (meth)acrylic syrup comprising at least one (meth)acrylic polymer and at least one (meth)acrylic monomer,
an aqueous dispersion comprising at least one radical initiator consisting of an organic peroxide, for initiating the polymerization of the (meth)acrylic monomer, said at least one radical initiator having a particle size such that the median diameter of the particles by volume (D50) is between 1 μm and 30 μm.

2. The impregnation process as claimed in claim 1, wherein the step of impregnating the fibrous substrate is performed in a closed mold.

3. The impregnation process as claimed in claim 1, wherein the radical initiator is selected from the group consisting of diacyl peroxides, peroxyesters, dialkyl peroxides, peroxyacetals and azo compounds.

4. The impregnation process as claimed in claim 1, wherein the radical initiator consists of benzoyl peroxide (BPO).

5. The impregnation process as claimed in claim 1, wherein the content of radical initiator relative to the (meth)acrylic monomer or to the mixture of (meth)acrylic monomers is between 100 and 50 000 ppm by weight.

6. The impregnation process as claimed in claim 1, wherein the percentage by weight of radical initiator in the aqueous dispersion is between 30% and 80%.

7. The impregnation process as claimed in claim 1, wherein the percentage by weight of radical initiator in the (meth)acrylic mixture is less than 5%.

8. The impregnation process as claimed in claim 1, wherein the aqueous dispersion of radical initiator has a viscosity at 20° C. of between 50 mPa*s and 1000 mPa*s.

9. The impregnation process as claimed in claim 1, wherein the (meth)acrylic polymer is a homopolymer of methyl methacrylate (MMA) or a copolymer of methyl methacrylate (MMA) or a mixtures thereof.

10. The impregnation process as claimed in claim 9, wherein the copolymer of methyl methacrylate (MMA) comprises at least 70% by weight of methyl methacrylate (MMA).

11. The impregnation process as claimed in claim 9, wherein the copolymer of methyl methacrylate (MMA) comprises from 80% to 99.7% by weight of methyl methacrylate and from 0.3% to 20% by weight of at least one monomer containing at least one ethylenic unsaturation that can copolymerize with methyl methacrylate.

12. The impregnation process as claimed in claim 1, wherein the (meth)acrylic polymer in the liquid (meth)acrylic mixture is present at an amount of at least 10% by weight of the total liquid (meth)acrylic mixture.

13. The impregnation process as claimed in claim 1 wherein the (meth)acrylic polymer in the liquid (meth)acrylic mixture is present at an amount of at most 60% by weight of the total liquid (meth)acrylic mixture.

14. The impregnation process according to claim 1, wherein the (meth)acrylic mixture further comprises an activator.

15. The impregnation process as claimed in claim 14, wherein the activator is selected from the group consisting of tertiary amines, N,N-dimethyl-p-toluidine (DMPT), N,N-dihydroxyethyl-p-toluidine (DHEPT), transition metal catalysts which are soluble in organic compounds, and mixtures thereof.

16. The impregnation process as claimed in claim 14, wherein the content of the activator relative to the (meth)acrylic monomer of the liquid (meth)acrylic syrup is from 100 ppm to 10 000 ppm (by weight).

17. The impregnation process as claimed in claim 1, wherein the (meth)acrylic mixture comprises between 95% and 99% by weight of (meth)acrylic syrup, and between 1% and 5% by weight of aqueous dispersion.

18. A liquid (meth)acrylic mixture for carrying out the process for impregnating a fibrous substrate as claimed in claim 1, wherein said (meth)acrylic mixture comprises:
a (meth)acrylic syrup comprising at least one (meth)acrylic polymer and at least one (meth)acrylic monomer,
an aqueous dispersion comprising at least one radical initiator consisting of an organic peroxide, for initiating the polymerization of the (meth)acrylic monomer, said at least one radical initiator having a particle size such that the median diameter of the particles by volume (D50) is between 1 μm and 30 μm.

19. A process for manufacturing mechanical parts or structured elements or articles, said process comprising the following steps:
a) impregnating a fibrous substrate as claimed in claim 1 with a liquid (meth)acrylic mixture as claimed in claim 18,
b) polymerizing the liquid (meth)acrylic mixture impregnating said fibrous substrate.

20. The manufacturing process as claimed in claim 19, wherein said process further comprises, prior to step a), a step of forming the liquid (meth)acrylic mixture by mixing a (meth)acrylic syrup comprising at least one (meth)acrylic polymer and at least one (meth)acrylic monomer with an aqueous dispersion comprising at least one radical initiator consisting of an organic peroxide for initiating the polymerization of the (meth)acrylic monomer, said at least one radical initiator having a particle size such that the median diameter of the particles by volume (D50) is between 1 μm and 30 μm.

21. The manufacturing process as claimed in claim 19, wherein the impregnation of the fibrous substrate in step a) is performed in a closed mold.

22. The manufacturing process as claimed in claim 19, wherein step a) and step b) are performed in the same closed mold.

23. The manufacturing process as claimed in claim 19, wherein the process is chosen from resin transfer molding and infusion.

24. A mechanical or structural part made of composite material obtained via the manufacturing process as claimed claim 19.

25. The part as claimed in claim 24, said part being a motor vehicle part, boat part, train part, sport article, airplane or helicopter part, spaceship or rocket part, photovoltaic module part, wind turbine part, furniture part, construction or building part, telephone or cellphone part, computer or television part, printer or photocopier part.
